(19) United States
(12) Patent Application Publication
(10) Pub. No.: US 2021/0409194 A1
(43) Pub. Date: Dec. 30, 2021

(54) CRYPTOGRAPHY METHOD

(71) Applicant: Michael Artmann, München (DE)

(72) Inventor: Michael Artmann, München (DE)

(21) Appl. No.: 17/288,709

(22) PCT Filed: Oct. 25, 2019
(86) PCT No.: PCT/DE2019/100924

§ 371 Date: Apr. 26, 2021

(30) Foreign Application Priority Data
Oct. 26, 2018 (DE) 10 2018 126 763.0

(51) Int. Cl. H04L 9/06

(52) U.S. Cl. CPC H04L 9/0656

(57) ABSTRACT

A method for encrypting digital data (A, E) by conversion, comprising the steps of accessing first digital data (D), wherein the first digital data (D) consist of at least one first unit, which has a data value and a data arrangement; accessing second digital data (A, E), wherein the second digital data (A, E) consist of at least one second unit which has a data value and a data arrangement; establishing a start condition, wherein the start condition has at least one start position based on the data arrangement of the first digital data; persistently retaining the data of the start condition; forming a first temporary data stream (B) from the first digital data (D) as a function of the start condition; and forming a cipher (C) by converting the second digital data (A, E), wherein the at least one second unit (a∈A) is converted using at least one predetermined function (⊕) as a function of at least one third unit (b∈B) selected from the first temporary data stream (a⊕b=c).

### TECHNICAL FIELD

The present invention relates to a method and a device for the symmetrical cryptographic encryption of digital data and the decryption thereof.

### BACKGROUND OF THE INVENTION

Methods and devices for encrypting digital data are known in the prior art and are used in virtually all fields of digital data processing. Here, the methods and devices are employed in particular in the transmission and saving of digital data. The internet already plays a significant role in daily life and is still increasingly gaining significance. The interlinking of services increased so rapidly in the past that there are nowadays barely any websites, apps or program which function without personal data.

Even on a simple company homepage, because of social media, the web layout and analytical functionality of search engine providers, dozens of connections are made to external services, which, in turn, may contact others. In this regard, personal data of website visitors are regularly also read out, saved and passed on. This crops up even more clearly in the case of web-based applications or programs on mobile communications devices, so-called “Apps”, which are dedicated to use in the processing of personal data, such as in the field of online banking, for example.

However, modern telecommunication standards and applications such as Machine-to-Machine (M2M) communication or very generally the communication of all possible devices within the framework of the so-called “Internet of Things” are ultimately based on the transmission of digital data.

The aforementioned examples show that both the data as such, e.g. in the field of online banking, and the communication between various devices, e.g. in M2M communication, must be protected in order to prevent any misuse.

Usability both in hardware solutions and in software solutions is of paramount importance, in single applications and in complex systems and the individual components thereof. A use which is as flexible and universal as possible is thus made possible for all fields and application cases.

Installed programs (by Setups) and applications (so-called apps), client server solutions (web services, cloud, chat, email, internet), component parts of the operating system (boot loaders, OS components, drivers, services) and in particular all data access, communication and network services are used as a software solution.

Regarding hardware solutions, mention should be made of control devices (Smarthome, Internet of Things, production plants with Industrie 4.0) for detection, communication and control, in particular peripheral devices (via radio connection in the case of keyboard, mouse and printer), and their boards with RAM- and ROM chips (Mainboards, BIOS).

In a combination of hardware and software, we are dealing with encrypted data on a structural level of data carriers (USB, SSD, hard disk) with their File System (FS), and their file contents encrypted on storage media (DVD, CD, Blu-Ray).

The current encryption methods require static keys, i.e. keys which are used again and again, such as passwords or PINS. These are generally relatively short, even just to enable the user to remember the appropriate keys. Due to the input possibilities, these are also subject to a number of restrictions by way of the character set, the keyboard, the device, its operating system, and the like. Above all due to the low information content (entropy), this leads to frequent repetitions (redundancies) within the large amounts of data which in the meantime are employed as standard practice. As a result, they are easy to detect by stochastic analysis. At least since the time of attack techniques such as Man-In-The-Middle (eavesdropping and manipulation between two communication partners) and the Brute-Force-Attack (systematic testing of all possibilities), none of the present methods, algorithms, protocols, etc. were able to hold firm. More complex keys, such as those generated, for example, by corresponding programs, are frequently saved on the relevant devices, such as mobile communication devices or even in the Cloud, but in turn are protected by simple keys which the user can remember. The gain in security by the complex keys is again often qualified by this.

Many of the encryption methods common nowadays are based on simple algorithms such as random number generators and use only simple bit operations such as exclusive-or (XOR). In the process, the data are linked with a particular function, such as XOR individually consecutively mathematically, in an information processing manner, and saved as cipher C, e.g. a=255, b=1

c=a XOR b

c=255 XOR 1=254

The use of XOR in encryption methods has disadvantages. An XOR with zero has no effect, e.g. in a text “private”, the text remains completely unaltered, as is shown by the ‘p’ in the calculation:

‘p’=112

112 XOR 0=112=‘p’

An XOR with zero applied discloses the key, e.g. in the case of “password” the complete password can be reproduced by repeatedly specifying zeros. Here, by way of example, the ‘p’:

‘p’=1121

0 XOR 112=112=‘p’

Furthermore, XOR applied twice yields the original value and thus the secret text:

a XOR b XOR b=a

‘p’=112

112 XOR b XOR b=112=‘p’

Through eavesdropping and the above conditions, mathematical equations can be formed and algebraically solved. This is the main point of criticism levelled at the current standard methods.

In particular, in the case of the block methods, the length (mainly 8 bytes) is static and relatively short, and in the case of all Advanced Encryption Standards (AES) it is 128 bits (16 bytes), even if a key length to 256 Bit has been selected, as in the case of AES-256. Without at this point going into methods made public more than 20 years ago, the effects of block methods will be generally explained below. On the one hand, it is the regularity of all n bytes and, on the other, it is the imaging function which have systematic effects. This leads to many redundancies, illustrated with the oscilloscope in FIGS. 6 to 8, where, by conversion, in a greatly simplified manner, a pattern can be recognised. In the process, the effect of XOR is overestimated. Here, it acts as an addition, although c=a XOR b has been used. Alongside this pattern formation, other disadvantages should be specified. In the example below, some weaknesses in encryption methods according to the prior art will be explained.

If the possibilities are looked at in professional programming languages such as C, C++ and C#, there is not a large selection of operations which can be reversed without losses. There are two of them:

| | | |
|---|---|---|
| Bitwise Complement, bitwise-Not | NOT | ~ |
| Bitwise Exclusive-or, exclusive-or | XOR | \hat{ } |

There is no shift function

Bitwise Rotation, Rotate Left/Right ROL, ROR

which is known from the assembler and it must take place by means of

Bitwise Shift, Shift-Left/Right SHL, SHR <<, >>

taking into account the transmission bit (Carry-Flag) or the like. This leads to several operations. In particular, at 128 bits on a 32-bit processor, this adds up to a considerable quantity in many rounds, which in turn leads to correspondingly elaborate computing processes and accordingly high requirements on the computer power.

Very often, the exchange of bits is applied. These must firstly be isolated (masked) by using

| | | |
|---|---|---|
| Bitwise And | AND | & |
| Bitwise Or | OR | \| |

In the following example, the process is shown in a 32-bit processor. The second Bit is taken on onto another at the second-highest position. All bits are set, so the entire sequence is superfluous, but some observations can be made.

| | |
|---|---|
| Firstly, the mask is formed | 1 << 1 = 2 |
| Isolated with AND to output value | 4294967295 & 2 = 2 |
| For the automation to starting position | 2 >> 1 = 1 |
| And bring now to the target position | 1 << 30 = 1073741824 |
| Mask in target value | 1 << 30 = 1073741824 |
| Form a bitwise complement with NOT | ~1073741824 = 3221225471 |
| Delete in the target with AND | 4294967295 & 3221225471 |
| | =3221225471 |
| Take over with OR | 3221225471 \| 1073741824 |
| | =4294967295 |

This example clearly shows that the exchange of bits involved some work. In particular through application in loops and several rounds, it nowadays still causes a noticeable time delay during encryption.

The above example is based on the processing of large numbers, such as several billions. For us humans, these magnitudes may appear impressive. In particular, when the values are seen in the decimal system, it suggests security and complexity, but for a computer such numbers have been standard since the 1980s. The same also applies to the operation. To us, the effects possibly seem tremendous, but in a computer it is only many wires to which current is applied, i.e. at one point in time there a state of affairs exists, which is moved into another state by switching.

It is a similar case with the large number of possibilities, such as 2 to the power of 32, 64 128 or 256. Here too, the number of possibilities sugggests security, but many of these theoretical possibilities cannot be formed in the algorithms used. Furthermore, the processes which follow one after the other are usually not independent, but rather build on one another. These weak points in the algorithm, in the case of the widespread AES for example, lead to a security margin of three (at 128-bit key length) to five rounds (at 256-bit key length) instead of 14.

Alongside this, there is the issue of the applicability of these theoretical possibilities in reality, i.e. whether a password of at least 37 characters for 256-bit key length (when using the complete ASCII character set) can be remembered. If the number of characters which are actually available on all devices are studied, there are 26 lower case and 26 upper case letters plus 10 numbers and only 6 bits are required for this.

In reality, many people use a short password, with 10 characters being common nowadays; therefore, with AES-256, 10*6 bits=60 significant bits are actually used. Therefore, a key expansion also takes place according to published algorithms which are likewise known to each attacker.

If you study the practice that 256 possibilities can theoretically be used in the case of one Byte, this is entirely different in the case of texts such as passwords and also in the case of texts to be encrypted. As a basis, the Latin lower-case letters are the most frequent characters. Thus, only 26 of 256 possibilities are effectively used (approx. 10%). Unicode is common nowadays, with 26 facing 65,536 possibilities here (approx. 0.04%).

In principle, an attacker also makes use of this strategy, by restricting the number of possibilities further and further. By way of example, the effects can be examined systematically by means of the published algorithms, as a result of which patterns can be identified and recognised. For this purpose, the attacker can employ letter frequency or—even better—the space character. Only one bit is set as ASCII code (American Standard Code for Information Interchange), it is also applicable as a word separator in many languages. If he employs projections and saves these in a so-called Lookup Table, it has become possible to perform comparison using patterns more simply and quickly’. Thus the attacker can restrict the possibilities again and again until one bit, byte or character is found and decrypted. The number of possibilities remaining is reduced so drastically, and shortly afterwards the cipher is broken and the password is revealed.

A large problem with all block encryption methods is the necessarily constant size. This is approached differently depending on the application, with the worst variant being not to encrypt, which is deadly with a text end such as

“ . . . daily password is abc1234”

The problem occurs frequently. In a text of 161 characters one character is left over in AES due to the block size of 16 bytes, usually the point, binary depiction: 00101110. 00101110. In a block of 16 Bytes, only 4 of the 128 bits are set and can be effectively used.

All current encryption methods have one thing in common. Regardless of whether current bit encryption or AES, which designates a byte-based processing, but nevertheless must function bitwise. The bitwise processing has only two degrees of freedom: “Change or Retain” and “Apply or Ignore”. The filling-up therefore leads only to two corresponding processes and patterns and, since the password (128 Bit) is directly initially applied, 128−4=124 bits are subjected to either all or no effects. The absolutely required filling-up of the blocks quickly leads to the password being deduced.

The basic case is that a cipher, i.e. encrypted data, based on the methods according to the prior art can be broken, i.e. all data are present again in plain text. The rapid technical development in the hardware field is also a problem. Thus, cryptography methods which for years have been deemed to be secure because, just a few years ago, the computing effort and thus the time expenditure for the systematic detection was, in the context of the possibilities at that time, extremely high, can be decrypted simply nowadays. This is due on the one hand to the rapidly increasing power of the main processors and their availability, and also on the other hand to the involvement of other processors, such as those of the graphics cards. Here, thousands of high-speed cores with register widths of 128 bit work in parallel processes at the same time. In order to take this into account, both key lengths and password lengths and also algorithms (in particular the number of rounds) have been expanded. The passwords have become correspondingly longer and more cryptic, and thus harder for the user to remember and at the same time the time required for the encryption also increased. The latter is a limiting factor in particular on devices with low processor power, such as in mobile communications devices or components of the so-called Internet of Things, such as household appliances which communicate with one another. Weaker encryption must frequently be relied on. The complete home network is therefore subject to weaker protection.

However, all the developments in the field of cryptography do not seem to gain traction, because cryptoanalysis, which deals with the analysis of cryptographic methods with the aim of evading these or cancelling the corresponding protection mechanisms, is making equal progress and also takes advantage of the possibilities of modern hardware. A 30-character password was cracked in a matter of seconds at a public event in 2017—and this was done on a normal, average laptop. There is therefore a need for alternative cryptographic methods.

### SUMMARY OF THE INVENTION

The problem of the present invention is to at least partially overcome the disadvantages known in the prior art. The above problem is solved by an inventive method according to Claim 1. Preferred embodiments of the methods are the subject-matter of the corresponding subordinate claims. In particular, a particularly clear, managable, compact and universally employable method is made available which in addition is simple to handle in a particularly user friendly manner (e.g. by completely doing away with any passwords) and makes low demands on the computing power. Due to the mathematic-stochastic model, through the “trend to infinite”, almost 100% security is also guaranteed —in particular with respect to all analysis methods and other attack techniques such as Man-In-The Middle and the Brute-Force-Attack.

The method according to the invention for encrypting digital data A, E by conversion, comprising the steps of accessing first digital data D, wherein the first digital data D consist of at least one first unit, which has a data value and a data arrangement; accessing second digital data A, E, wherein the second digital data A, E consist of at least one second unit, which has a data value and a data arrangement. The method according to the invention furthermore comprises establishing a random outer start condition from which an inner start condition can be determined as a function of the length of the first digital data D, wherein the inner start condition has at least one start position based on the data arrangement of the first digital data D; persistently retaining data of the outer start condition and forming a first temporary data stream B from the first digital data D as a function of the inner start condition. A temporary data stream in the sense of the present invention is a data stream through selection of units from digital data and/or through mathematical, stochastic and/or information-technology processing of digital data of the non-persistent saved data stream. Accordingly, the first temporary data stream can be formed reproducibly from the first digital data on the basis of the start condition and, if necessary, through the mathematical, stochastic and/or information-technology processing. Temporary in the sense of the present invention is in particular the saving in volatile storage media, such as the working memory of an electronic device, and the direct generation of the data stream in the conversion without the data stream as such being saved. In particular, this also comprises the selection of individual units for the conversion according to the invention. The method according to the invention further comprises forming a cipher C by converting the second digital data A, E with the first digital data stream B by applying a predetermined function, wherein the predetermined function in particular is an information-processing, mathematical link (⊕) defined on the individual units (e.g. a⊕b=c). In accordance with the present invention, each of the at least one second units of the second digital data is converted with, respectively, a third unit of the first temporary data stream according to the predetermined function. In particular, in accordance with the present invention, each of the at least one second units is converted with another third unit using the predetermined function. The third units to be used for the conversion according to the predetermined function could be successive units of the first temporary data stream. However, the third units can also be selected based on a predetermined ruleset from the first temporary data stream. According to the present invention, the predetermined ruleset can determine the position of the third units to be used, but can also comprise validation functions of the third units. Validation functions in the sense of the present invention are functions which examine the correct applicability of a third unit, for example with regard to their values, during conversion. If it hereby emerges from the examination that the use of a unit in the converion using the corresponding predetermined function does not yield any result, i.e. is not mathematically possible, for example, or would not lead to any alteration, an alternative is determined.

Digital data in the sense of the present invention is understood to mean all types of computer-readable data. These digital data can, in the sense of the present invention, be temporarily or permanently saved in any type of computer-readable memory, in particular volatile and non-volatile storage media. Digital data in the sense of the present invention can be both individual streams, i.e. a unit of data which logically belongs together, and several streams. Digital data can be, in particular, files determined by a user, such as digital photos, digital audio files, digital text files and the like, or streams. Digital data can, in particular, also be data of digital communication. Digital communication in the sense of the present invention hereby comprises both human communication, i.e. text data, image data or audio data, human-machine communication and M2M communication, wherein, in particular, alongside the information to be transmitted, the data for exchange, switching, addressing and the like are comprised.

Digital data in the sense of the present invention consist of a data value and a data arrangement (value, byte position and bit position) and therefore can be managed in data stream. From the data arrangement, there emerges a data position, which in turn is a number, i.e. can only assume whole values. One data value can be ascertained at one data position, with the data value also being a number, i.e. can only assume whole values. All these numbers are viewed and treated equivalently.

Start condition in the sense of the present invention is to be understood as the conditions, settings and the like, which existed at the start of the encryption. They thus guarantee the recovery of the original during decryption, by means of the same conditions. In particular, the start position is important because it must necessarily be transmitted as an individual value and means the jump-in/starting point of the encryption and decryption. In this case, the actual position is transmitted in an outwardly concealed manner. The external position is a very large random number at the beginning of the encryption and is at least 64 Bit, approx. 1.8e19 as a number. The required inner position can be extrapolated from the outer position through the remainer function (modulo) from the total length which is publicly unknown.

Persistent retention of data in the sense of the present invention is understood to mean any form of the digital and also analog saving, as well as the representation for the transfer of information to the user. In particular, the persistent retention of data can be a saving in combination with the cipher.

Cipher, in the sense of the present invention, is understood to be the result of the cryptographic encryption method through conversion.

According to a preferred embodiment of the method according to the invention, the conversion takes place using the at least one predetermined function as a function of the data value and/or the data arrangement. The predetermined function can be securely stored, e.g. saved in the program code, or be saved at a suitable location in the hardware, or can be temporarily selected by the user from a group of possible functions or freely input by the user. The used function can thus be persistently saved with the program code or otherwise.

In a further embodiment of the present invention, the first temporary data stream can be a circular data stream. A data stream in the sense of the present invention can accordingly be viewed cyclically, i.e. if a calculated position of a third unit in the data stream is greater than or equal to the number of the data of the data stream, then positioning is carried out anew from the beginning of the file. In a further preferred embodiment, the at least one third unit can be processed, by means of predetermined functions and variables, from the temporary data stream. In a further, preferred embodiment, data values and data arrangement of the at least one third unit can be applied recursively.

In a further embodiment of the present invention, the second digital data A are formed by adaptations prior to conversion by means of mathematical, stochastic and/or information-technology processing based on second digital raw data E. In the sense of the present invention, any conceivable reversible adaptation can be to A from E and processing to B from D of the raw data. Accordingly, the processings, in the sense of the present invention, my represent in particular a mathematical, stochastic and/or information-technology rocessing, which lead to a reversible alteration of the arrangement of second units A, or the first units B respectively.

According to a further embodiment of the present invention, the second digital data E can form a second temporary data stream A. Accordingly, the second digital data can be formed temporarily from corresponding raw data, without being persistently saved.

In a further preferred embodiment, if it is not possible to access the first digital data D for the encryption, an appropriate replacement can be accessed. This can be a predetermined data stream, for example a data stream stored in the program code, a data stream linked to program code or can also be a predetermined data value. Accordingly, e.g. in emergencies, a limited encryption strength can ensure a minimum level of security during the communication.

A further preferred embodiment of the present invention is directed at the decryption of ciphers C formed in accordance with the method according to the invention. Accordingly, the method for decryption can have the following steps:

Accessing the cipher;
accessing a start condition;
Accessing first digital data D, wherein the first digital data D consist of at least one first unit, which have a data value and a data arrangement and correspond to the digital data used for the encryption;
Reversal of the conversion, wherein in each case one unit of the cipher (c∈C) is formed by reversed application of a predetermined function used in the encryption, as a function of at least one third unit, wherein the at least one third unit is a unit from a first temporary data stream B, wherein the first temporary data stream B is formed from the first digital data D at least as a function of the start condition.

According to a further preferred embodiment of the present invention, the method for decrypting the cipher C comprises the reversal of the adaptations on the basis of performing, in reverse order on the second digital data from A to E, the steps carried out during the adaptations. In this case, the data stream A resulting from the reversal of the conversion can be a temporary data stream. Accordingly, the progression of the processing takes place from D to B, so that the reversal of the conversion is formed from the resulting temporary data stream A.

Accordingly, the reversal of the conversion takes place by means of the processing from D to B, from which the temporary data stream A results.

A further preferred embodiment of the present invention is aimed at a device for encrypting or decrypting digital data comprising a processor and a storage medium, characterised in that the device is configured to carry out the method according to the invention.

A further preferred embodiment of the present invention is directed towards a computer program with program code for performing the method according to the invention, when the computer program is executed on a processor.

A further preferred embodiment of the present invention is directed towards a storage medium with instructions stored thereon for performing the method according to the invention, when these instructions are executed on a processor.

### BRIEF DESCRIPTION OF THE DRAWINGS

FIG. 1: shows the encryption data flow;

FIG. 2: shows the decryption data flow;

FIG. 3: shows the data flow for first digital data;

FIG. 4: shows the data flow for second digital data;

FIG. 5: shows the data flow directly on first and second digital data;

FIGS. 6 to 8 show the formation of patterns according to the prior art methods;

FIG. 9: shows the data processing from jumps visualised in the oscilloscope;

FIGS. 10 and 11: show the adaptation through division and subsequent reversal of the order;

FIG. 12: shows the adaptation through the summarising of equal values;

FIGS. 13 and 14: show the adaptation and improvement of the scatter, concealment of ASCII;

FIG. 15: shows the improvement of the transition, prevention of file-type recognition;

FIG. 16: shows the introductory example from FIG. 7 as improved base B by use of the addition;

FIG. 17: shows an introductory example from FIG. 8 as improved cipher using base B from FIG. 16 and applying the addition; and

FIG. 18 shows a practical example from real-life use

### DETAILED DESCRIPTION

The principle underlying the present invention is clearly described below with reference to the acronym “ARTOO”. Therein:
A=Automatically, simple to handle as a fully automatic method
R=Randomizing, the provision of non-deterministic random values
T=Transformation, quickly executable, as compact in the algorithm
OO=Infinity, the sign for infinity

Summary: If an algorithm for encryption uses an infinitely long, non-deterministic basis for the encryption, then the cipher cannot be broken.

This “ARTOO” basic principle is understood and applied in the method described here such that:
infinity is meant in the sense of unlimited, without restrictions, any number, not rigidly fixed, not constant, but rather variable and flexible
the random numbers are not only the basis for arithmetic operations, but rather also contribute to controlling, selecting, etc. Thus, a breakthrough is made to a firmly fixed scheme for processes
the application of a simple conversion (transformation) promises improvements for users and permits universal fields of application
the automatic process largely protects against operating errors and the like.

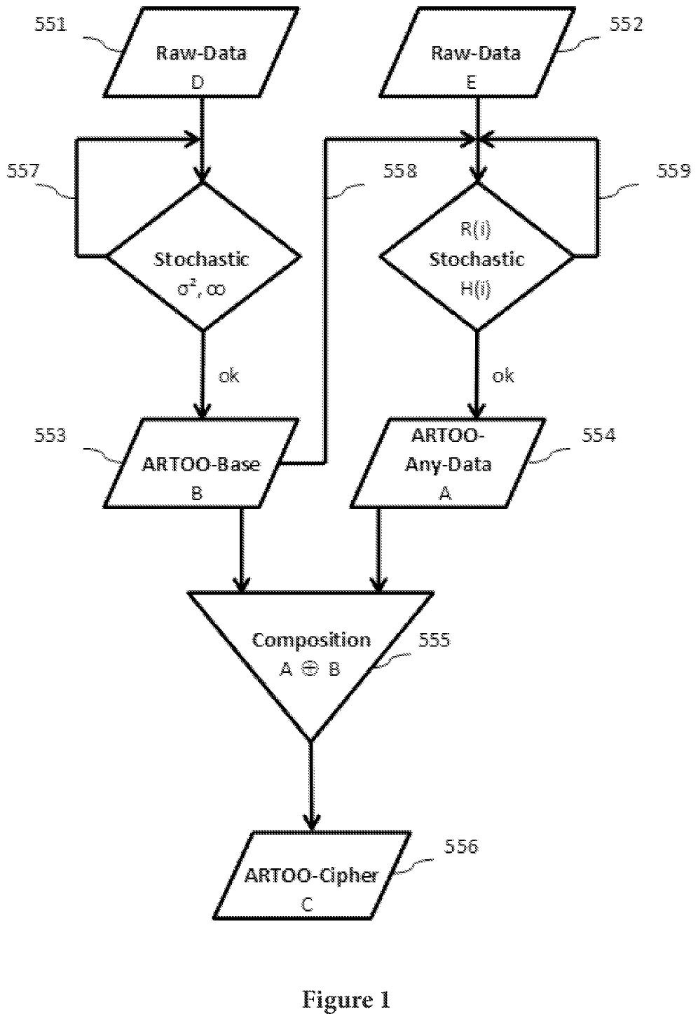

The priority is always the high degree of quality. Hereafter, aspects of the present invention shall be presented in detail, with FIG. 1 showing a schematic diagram of the data flow.

The left branch shows the transition of the raw data D 551, which have been individually set up by the user, to the encryption base B 553. This provides any number of non-deterministic byte values. The plurality of values permits an increase in quality by values being summarised in a bitwise manner 557. Viewed stochastically, the scatter (variance) is thus raised until good quality is attained, and thus they form the first digital data.

The right branch depicts the transition of the data E 552 to be encrypted to the working data A 554. Here, the data to be encrypted are processed bytewise in form, content and arrangement such that the attacker is able to make as few assumptions as possible 559. They form the second digital data.

The right branch makes use of the random numbers of the left 558 for this. By using the non-deterministic base B, the working data A are also influenced in a strongly non-deterministic manner.

As the quality is now very high, a simple and rapid conversion (transformation) can take place 555. From a mathematical, information processing perspective, A⊕B=C is a reversible linking of elements of the quantities. Demonstrated in the simplest case by addition c=a+b.

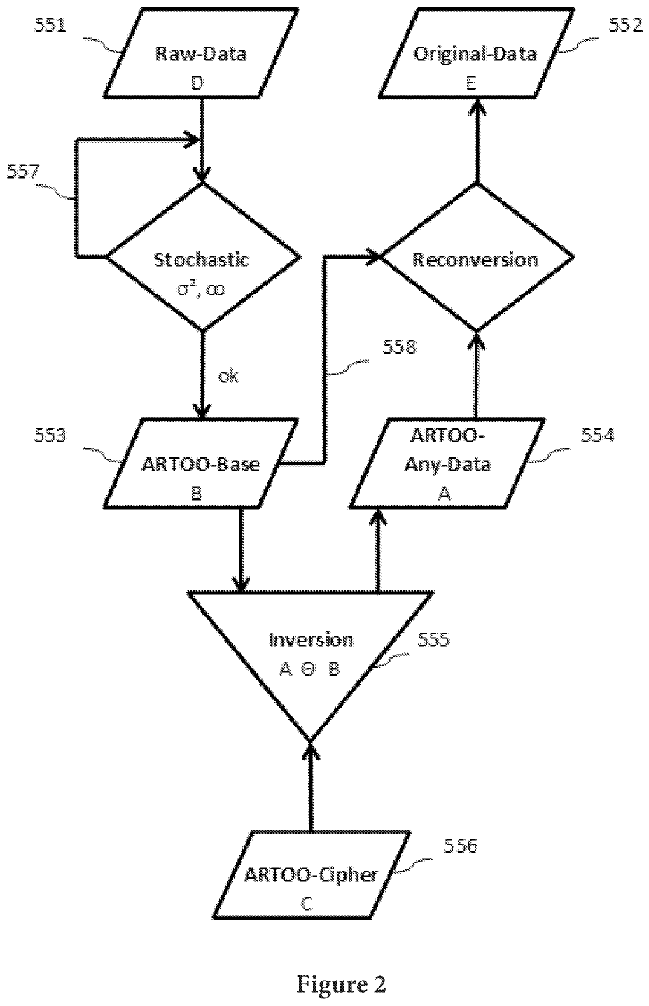

In order for a copy of the original to be able to be formed by decryption, in this embodiment the cipher 556 must know at least the start in D 551, so that B 553 can be reconstructed. If the conversion is inverted, here a=c−b, then A 554 has thus been recovered. If several steps for A were employed one after the other, these have to be undone in the reverse order for the decryption, in order to thus obtain a copy of the original E, as is depicted in FIG. 2.

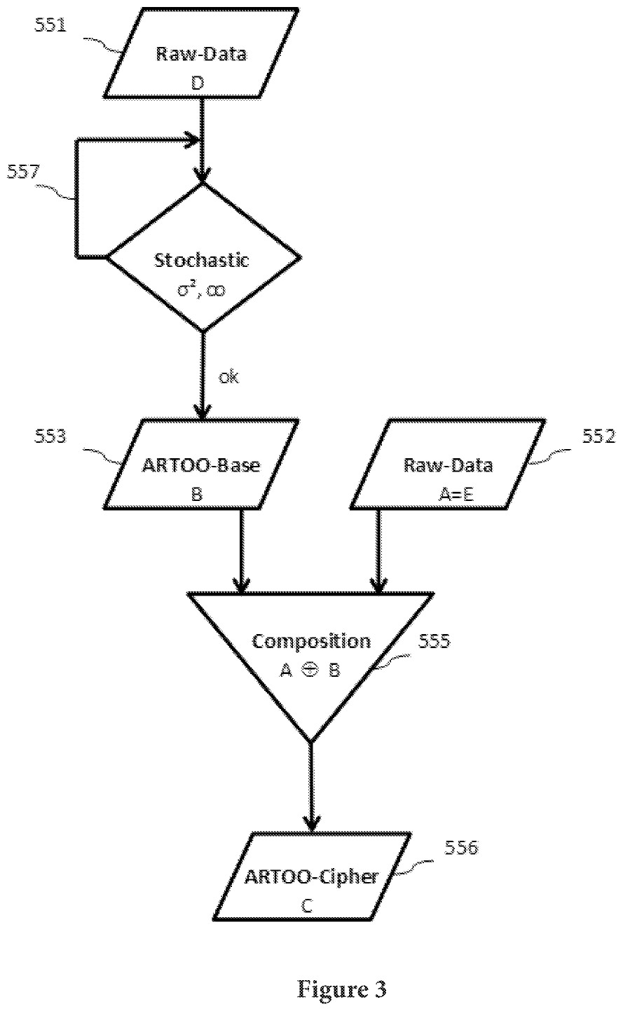

FIG. 3 depicts an embodiment of the encryption method according to the invention, in which the conversion is performed only on the first digital data (B, D), and the second digital data are therefore not altered prior to the conversion.

In order to be able to fulfil the requirements, the files selected by the user or stored in the index must firstly be viewed in a common data stream. As an example, three files d1, d2, d3 with 3, 2 and 3 Bytes are presented, which, linked together by means of the File Concatenate that is customary in computing, for a stream b. Streams are distinguished in that a positioning can be carried out directly, with counting starting from 0.

| d1 | | | d2 | | d3 | | |
|---|---|---|---|---|---|---|---|
| d1 1 | d1 2 | d1 3 | d2 1 | d2 2 | d3 1 | d3 2 | d3 3 |

b

| | | | | | | | |
|---|---|---|---|---|---|---|---|
| b0 | b1 | b2 | b3 | b4 | b5 | b6 | b7 |

At the end of the data stream, or if a position is greater than or equal to the total length, you continue from the beginning using the modulo function (remainder function %). For example, if a position is of 10 in the case of a total length of 8, then 10% 8=2.

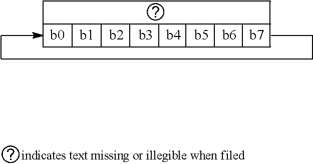

Thus, the actual positions can be concealed outwardly. Values such as 206.855.898% 8 or 299.525.537.761.704.834% 8 also give 2.

This is a difficult obstacle for an attacker, because he does not know the files, and thus doesn't know the total length which he requires in order to ascertain the position. The number is always newly determied from real random numbers and is at least 64 Bit, approx. 1.8e19. Through the remainder function (modulo) from the total length, it is possible to easily conclude the required inner position from the external position which is made public. These details are not known to an attacker, neither the amount nor the actual lengths and thus also not the total length. Outwardly, only a very large number is visible. In Terabytes, the maximum for 64 Bits is

2\hat{ }64=16,777,216 TB

and would comprise the capacity of thousands of hard drives. In fact, the actual inner start position cannot be guessed, provided that it is always independently newly determined in a stochastic manner. As the sole value which has to be transmitted publicly, this outer start position is very important. The value should be so large that it is immediately clear to any attacker that it cannot be a real value. It is advantageous if no system, such as through pseudorandom numbers or direct reference to the actual database, is used. If the formation of random numbers as a function of functions and their variables is viewed stochastically, it is better to use two functions with different influences. If different variables respectively are used, both functions are also “strictly independent” of one another. The same principle applies in reverse, in particular for series (sequences) of value from algorithms (functions).

As the position is made public as the outer start position, a further independent method is advisable, one of which is explained here. Here, the time at the start of the program (only the microseconds), the time of the action (only the microseconds) and the current mouse XY-position halted. If these are joined together bytewise, a very large position value of 230 TB is obtained.

| | | /255 | %255 | [0.255] |
|---|---|---|---|---|
| SystemTicks1 | 999888 | 3 [symbol] 5 | 208 | + |
| | 3905 | 15 | 65 | + |
| | 15 | 0 | 15 | − |
| MouseX | 1920 | 7 | 128 | + |
| | 7 | 0 | 7 | − |
| MouseY | 1080 | 4 | 56 | + |
| | 4 | 0 | 4 | − |
| SystemTicks2 | 111222 | 434 | 118 | + |
| | 434 | 1 | 178 | + |
| | 1 | 0 | 1 | − |

| | |
|---|---|
| Byte | 208 65 128 56 118 178 |
| Number | 228. [symbol] 79.742.635.698 |
| kB | 1.024 |
| MB | 1.048.57 [symbol] |
| GB | 1.073.741.024 |
| TB | 1.099.511.627.776 |
| Max | 18.44 [symbol] .744.073.709.500.000 |

[symbol]

indicates data missing or illegible when filed

Hereafter, the use of the start position will be described. The start position should be understood like an initial value, with which we obtain further values which are used for data-processing and for program control. The further explanations show how you come to a specific file from outside over any number of files. On the basis of the data contained therein, any number of data are then provided through a process (algorithm).

The principle of how any number of random numbers can be raised is a main factor of this encryption. A stream with 1 MB, for instance, serves for illustration, which is 7 JPEG images of 16 megapixels on a smartphone. Simplified to our decimal system, the total length is 1,000,000 Bytes, the values are approximated on the decimal system, e.g. a value of 99 at position 123.499.

Firstly, we require a random start position, which an attacker does see, but which does not correspond to a real position specification. This is similar to a transition between reference systems, in order to reach an Inner Position (the main system) from an Outer Position (public system).

If an Absolute Data Stream over all files (as the Main System) is not available in the programming language, an intermediate step is required. The next example applies the above number 228.979.742.635.698 in a support table. It shows how the Inner Position is ascertained via this Outer Position in order to then be able to ascertain the File Position 35.698 in file #3. In particular, for hardware-related programming of operating system components, drivers, and the like, the File Position must be used in older programming languages such as C.

228.979.742.635.698 Outer Position
228.979.742.635.698 mod 1.000.000 = 635.698 Inner Position

| Name | Length | Offset | # | | |
|---|---|---|---|---|---|
| data01.jpg | 200.000 | 0 | 0 | | |
| data02.jpg | 200.000 | 200.000 | 1 | | |
| data03.jpg | 200.000 | 400.000 | 2 | | |
| data04.jpg | 200.000 | 600.000 | 3 | 35.698 | File Position |
| data05.jpg | 100.000 | 700.000 | 4 | | |
| data06.jpg | 50.000 | 750.000 | 5 | | |
| data07.jpg | 50.000 | 800.000 | 6 | | |
| | 1.000.000 | | | | |

In a data stream, as well as in a file (Stream, File), positioning is carried out absolutely or relative to the present position with a File Pointer (Read/Write Pointer). A relative positioning represents a jump to a new, absolute position.

| # | Position | Value | Next |
|---|---|---|---|
| 0 | 635.698 | 98 | 635.796 |
| 1 | 635.796 | 96 | 635.892 |
| 2 | 635.892 | 92 | 635.984 |
| 3 | 635.984 | 84 | 636.068 |
| 4 | 636.068 | 68 | 636.136 |
| 5 | 636.136 | 36 | 636.172 |
| 6 | 636.172 | 72 | 636.244 |
| 7 | 636.244 | 44 | 636.288 |
| 8 | 636.288 | 88 | 636.376 |
| 9 | 636.376 | 76 | 636.452 |
| 10 | 636.452 | 52 | 636.504 |
| 11 | 636.504 | 4 | 636.508 |
| 12 | 636.508 | 8 | 636.516 |
| 13 | 636.516 | 16 | 636.532 |

Although this example is so simple because there is a direct correlation between position and value and additionally influences itself, it already shows a good sequence of “Short Distance Jumps” in the framed area.

Another possibility is that you read a value and increase the File Pointer by 1. This is the classic sequential behaviour for file accesses (reading, writing). The increase in the position is very important, otherwise the File Pointer would always supply the same values on the same location.

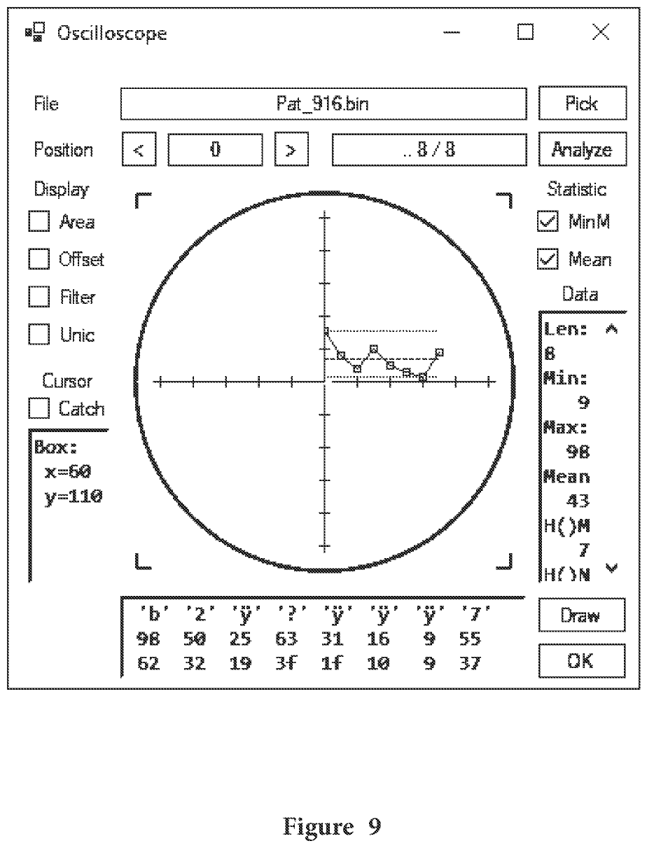

As a third possibility, the present position can be averaged with the total length. A jump is thus substantially larger than the value range of a byte [0 . . . 255]. The next FIG. 9 and the calculations show sequential jumps and long-distance jumps in an alternating behaviour:

| | # | Position | Value | Next | |
|---|---|---|---|---|---|
| Start | 0 | 635.698 | 98 | 635.699 | 98 |
| | 1 | 635.699 | 99 | 817.850 | Jump(1.000.000 + 635.699)/2 |
| | 2 | 817.850 | 50 | 817.851 | 50 |
| | 3 | 817.851 | 51 | 908.925 | Jump(1.000.000 + 817.851)/2 |
| | 4 | 908.925 | 25 | 908.926 | 25 |
| | 5 | 908.926 | 26 | 954.463 | Jump(1.000.000 + 908.526)/2 |
| | 6 | 954.463 | 63 | 954.464 | 63 |
| | 7 | 954.464 | 64 | 977.231 | Jump(1.000.000 + 954.464)/2 |
| | 8 | 977.231 | 31 | 977.232 | 31 |
| | 9 | 977.232 | 32 | 988.616 | Jump(1.000.000 + 977.232)/2 |
| | 10 | 988.616 | 16 | 988.617 | 16 |
| | 11 | 988.617 | 17 | 994.309 | Jump(1.000.000 + 988.617)/2 |
| | 12 | 994.309 | 9 | 994.310 | 9 |
| | 11 | 994.310 | 10 | 997.155 | Jump(1.000.000 + 994.310)/2 |
| | 12 | 997.155 | 55 | 977.156 | 55 |

In conclusion, the three presented examples have their own peculiarities:
The sequential access (successive one after the other) is standard, the low “consumption” of data is advantageous.
The application of “long-distance jumps” results in positions which are extremely difficult for an attacker to reproduce, as unknown variables (such as total length) are used, which have a meaningful effect (different file at different position).
“Short Distance Jumps”, as shown above in the calculation, offer a degree of balance between consumption and attack strength.

As a further measure for the objective of as high a degree of security as possible, the control of jumps takes place by means of real random numbers. This is because the main target of attack is the start position, because it is known. It is advisable to jump at least once at the beginning of the encryption. The number and selection are taken from the data of the stream and are thus random. As this is necessary only once at the beginning, the time requirement can be ignored and a recursive search behaviour over the entire stream is also acceptable. An application buffer can be filled with random numbers. From this, there emerge further possibilities in the behaviour, such as regular jumps, random presets and others.

With the application buffer, filled with random numbers, it is possible to make a selection of a particular function. It results in a non-deterministic behaviour which makes the method secure. As explained above, there are several possibilities in the case of jumps. In the method, from a byte value such as 128, the selection can be made from 3 functions f0, f1 or f2 through modulo (f2 is invoked here):

128%3=2

In order to be able to guarantee the aim of a security which is as high as possible, the value range of the data should be involved. As explained above, the bits are weakly occupied in particular with ASCII and Unicode files. To increase quality, in certain circumstances a compression of the data can take place automatically. For this purpose, data are read and summarised until the necessary quality has been reached. An example with Unicode-32 in the first digital data D with the text “XY” depicted hexadecimally and summarised as a half byte compresses it to 2 to the power of 8 instead of 2 to the power of 64 by the factor 2 to the power of 56=281,474,976,710,656:

| | | |
|---|---|---|
| Raw data: | 00, 00, 00, 58, 00, 00, 00, | 59 |
| Selection: | 58, | 59 |
| Compression: | 8 | 9 to hex 89 |

Finally a conversion A⊕B=C takes place, where the individual bytes respectively from A and B are linked with a predetermined mathematical, information-technological function.

In order to achieve the aim of secure encryption, some fundamentals of cryptology (cryptography for the protection of the information and cryptoanalysis for cancelling the protection) must be borne in mind. With reference to the present invention, the following advantages must be specified:
As few clues as possible for the attacker, here only one value, the start position, is necessarily made public.
Use of independent variables, here on the one hand the system time in fractions of a second, and on the other a data stream.
Providing a large number of possibilities. Here in particular:
   many functions are available as a set, which are also able to be combined (like the OO in the ARTOO principle)
   several influencing variables are used, e.g. value, or position, or both (the R in the ARTOO principle)
   more possibilities (stochastic) through viewing in bytes (minimal 256) compared to a bit with two possibilities (the OO in the ARTOO principle)
   real random numbers (individual files, unpredictable contents, the R in the ARTOO principle)
   no restriction (block sizes, key lengths) thus any number of values (the OO in the ARTOO principle)
The mode of operation of a program can be reproduced by any attacker, whether this be through disassembling or re-engineering. This invention offers many logical bifurcations. It deliberately prevents one step from exactly following another and being foreseeable.

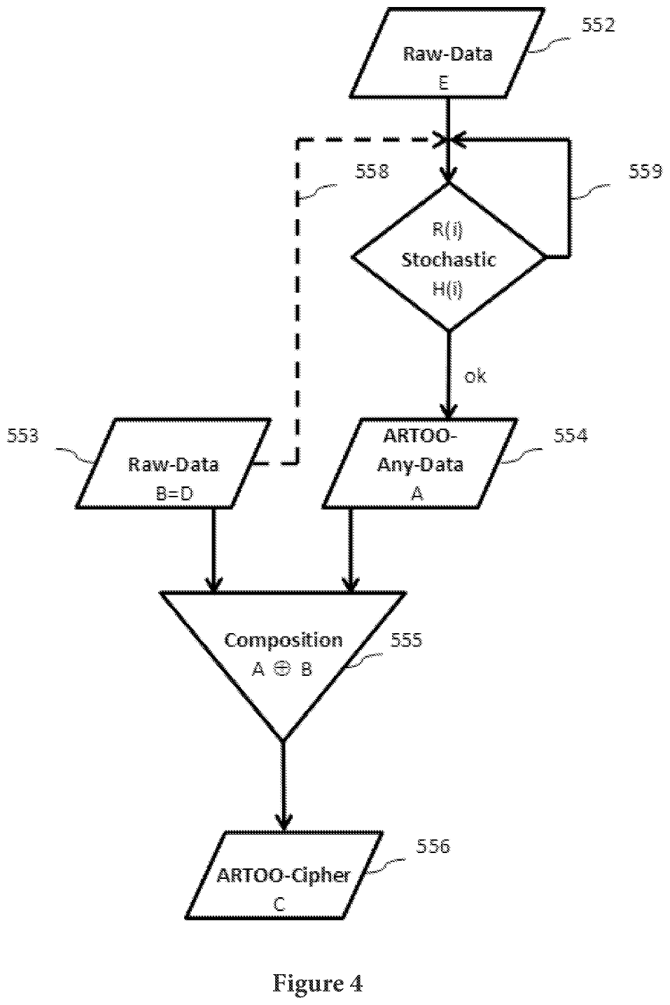

FIG. 4 depicts a further embodiment of the encryption method according to the invention, in which the conversion is performed only on the second digital data A and E, and the first digital data are not altered before this, i.e. B is equal to D.

The raw data D 553 are not processed and are viewed cyclically as B. They control the group formation 559 and influence the contents thereof through the provision of random numbers 558.

A configuration file can additionally regulate general options. These conditions which prevail at the start are referred to as Start Condition. In particular, the start position, as part of the Start Condition is responsible for which random numbers are available at the start of the encryption and decryption.

The aim of a secure encryption is shown by means of an example of the present invention. A fundamental problem in application protocols is the well-known response behaviour which an attacker can make use of. On the web (WWW), the browser requests the data (resources) with “GET”. In the case of a website with nine embedded graphics, that is 10 GET requests and 10 HTTP responses such as

HTTP/1.1 200 OK\

to 15 characters plus line end, which exactly corresponds to the AES block length. With the general approach A⊕B=C, the attacker has an equation system, wherein A and C are known and the effects thereof can be formed, refined and traced back using patterns.

As a measure against this, groups can be used and rearranged. In principle, these are datablocks without fixed length, which are managed in a concatenated manner. This would yield a block chain, which could lead to mix-ups. The designation of group and list is general and unambiguous.

For performance, a random number of B=D is requested and processed, e.g. at a value 255; processed according to the last decimal place to: 5. Then two groups are formed and exchanged. The result is:

1.1 200 OK\HTTP/

and thus an attacker cannot rely on a beginning with “HTTP”.

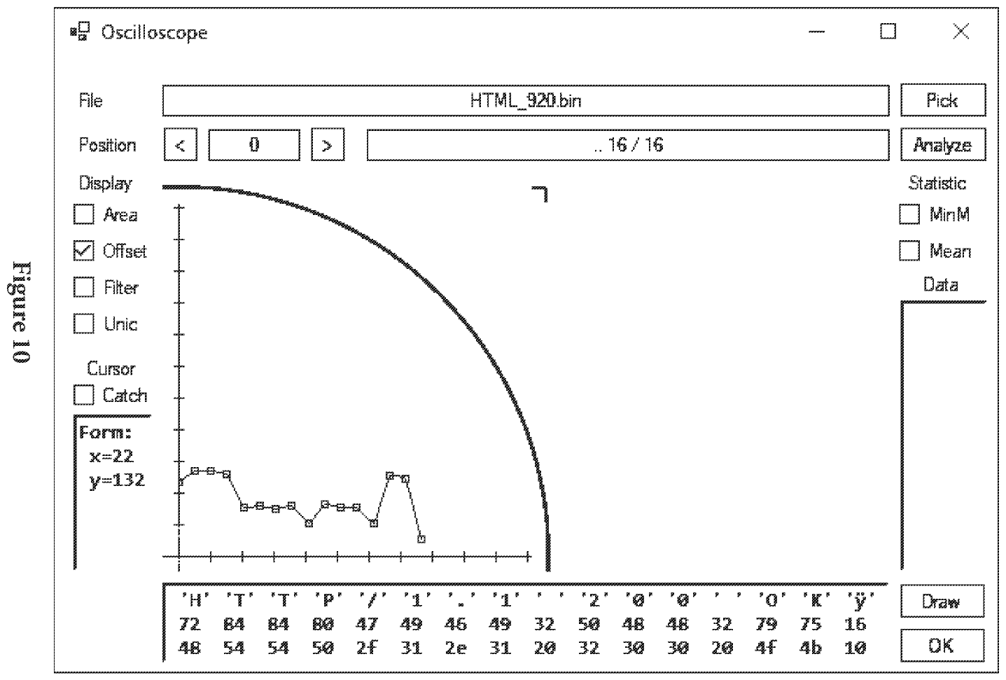

Another example is the B from FIG. 10. From the division and subsequent reversal of the order, there arises, using;

0, 1, 2, 3, 4, 5, 6, 7, 8, 9, 10, 11, 12, 13, 14, 15, . . .

from

HTTP/1.1 200 OK\

the division to

H|TT|P/1|.1 2|00 OK|\|

after reversal of the order thus

\|00 OK|.1 2|P/1|TT|H|

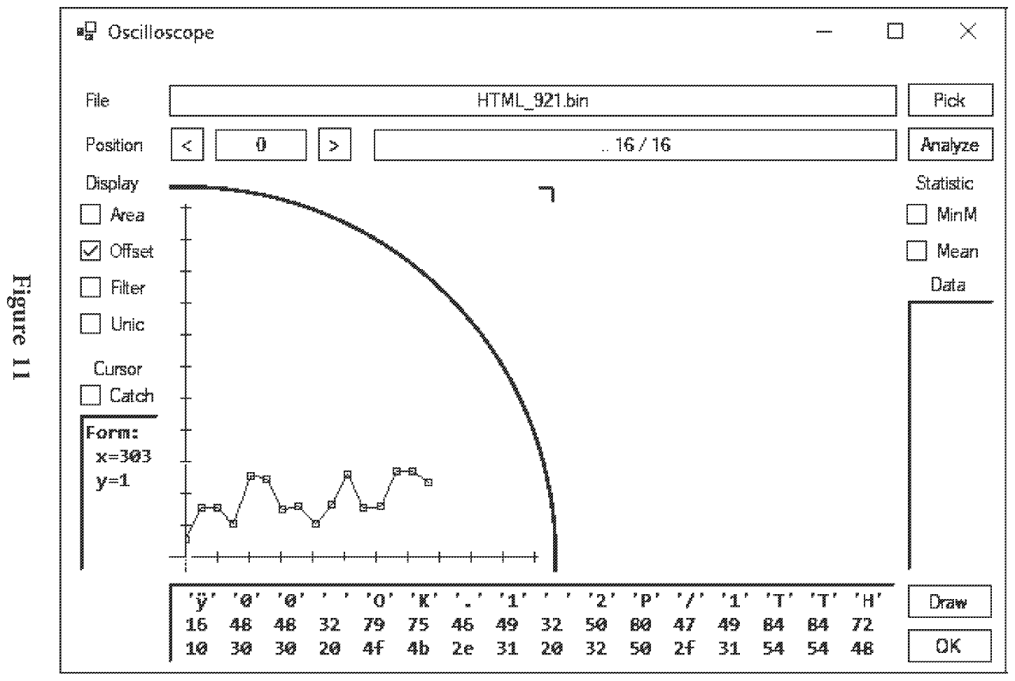

which no longer has much in common with the original format of the HTTP status, as is also shown by FIGS. 10 and 11.

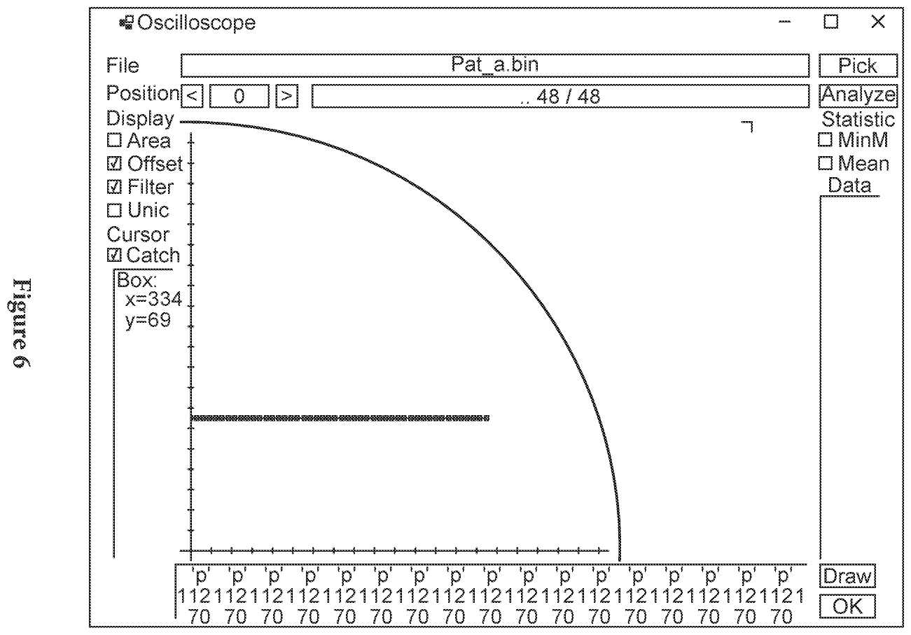

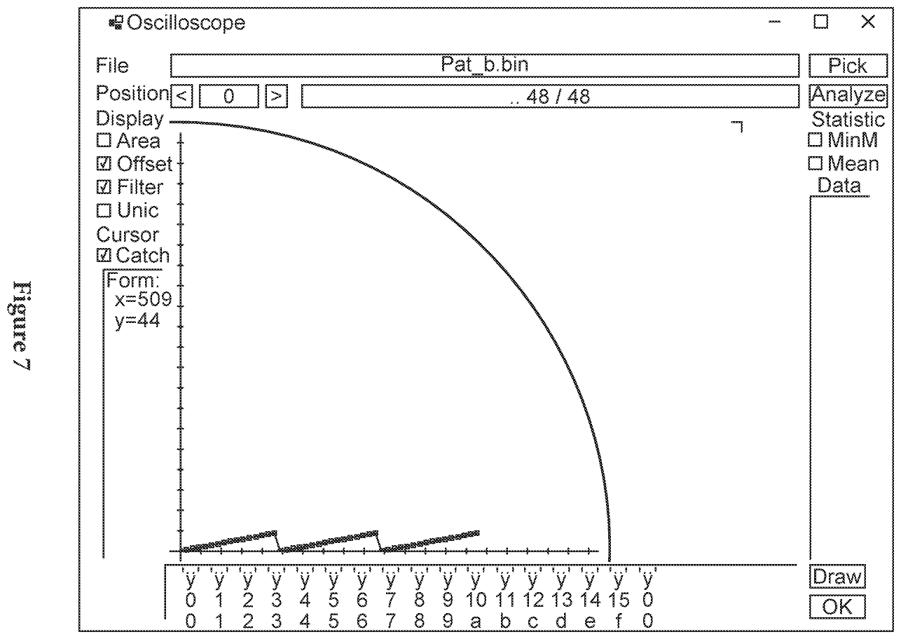

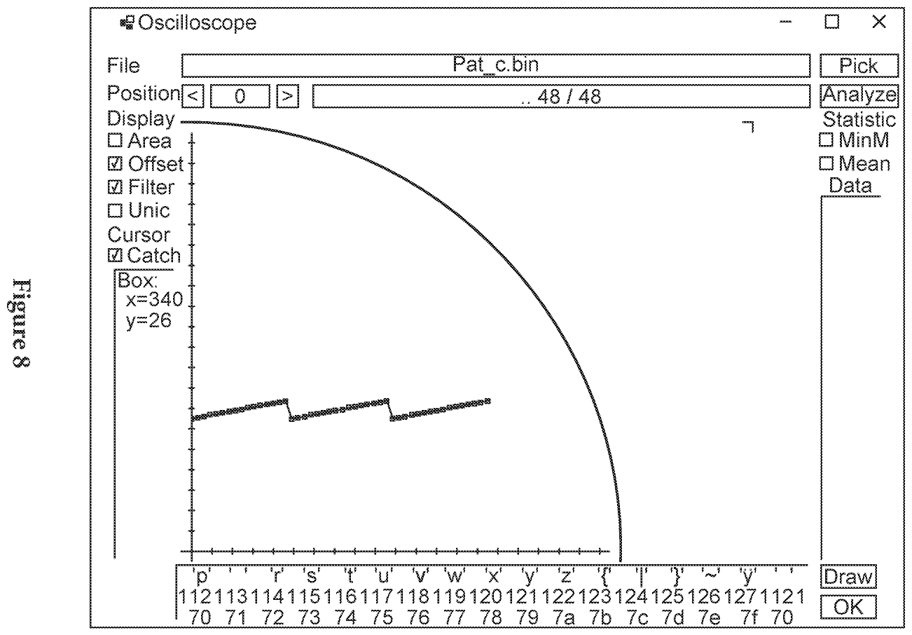

The summarising of equal values represents a further measure against attacks. In the example, FIG. 6, the letter ‘p’ is shown 48 times. This can be summarised to

16*112

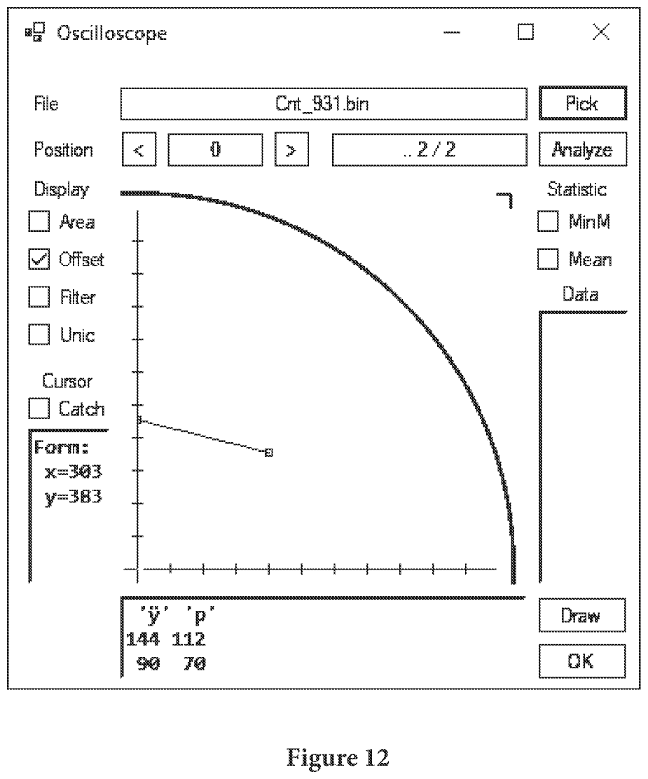

In the transmission, use is made of the fact that ASCII does not use the highest bit. If this is detected during decryption, up to 127 characters can be recovered, which is depicted in FIG. 12.

The alteration of contents as a further measure against attacks is similar. Hereafter, a protocol of machine control is depicted, as used in vector graphics in computers, plotters or in the web as SVG:

MOVETO:100:200;

LINETO:300:400;

. . .

The format of the protocol definitely must be known, so that two devices from different manufacturers can communicate with one another. According to the ASCII table, only a region from (hexadecimal) 0x30 to 0x5F is used. That is 3*16=48 possibilities of a total 256, i.e. around 19%. The limitation in the value range is bad from a stochastic perspective, but can be improved through an adaptation, similar to a coordinate transformation (shift of the origin and subsequent scaling). Through identical settings in the configuration file (.ini) on both devices with

[Adjust Content]

Origin=48

Scale=5

the region

0x30:(48−48)*5=0

0x5F:(137−48)*5=235/255 max.

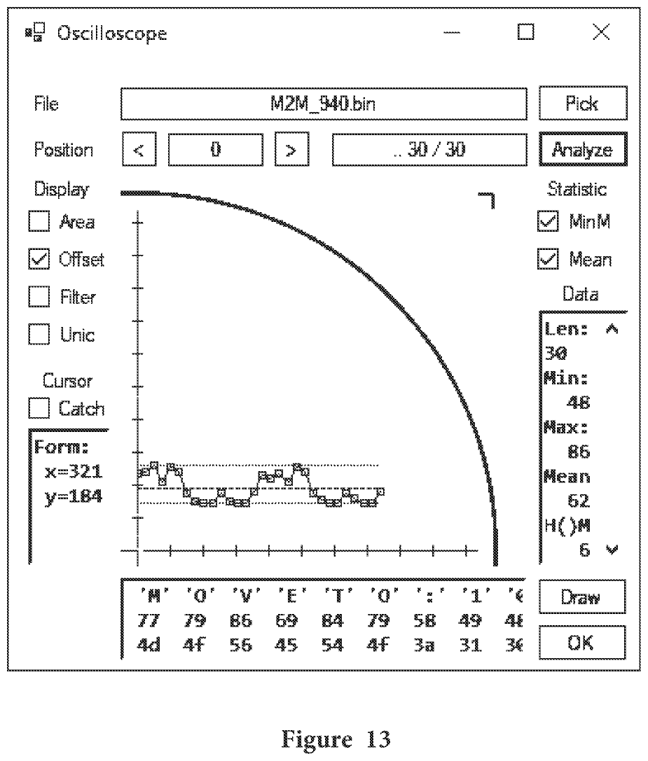

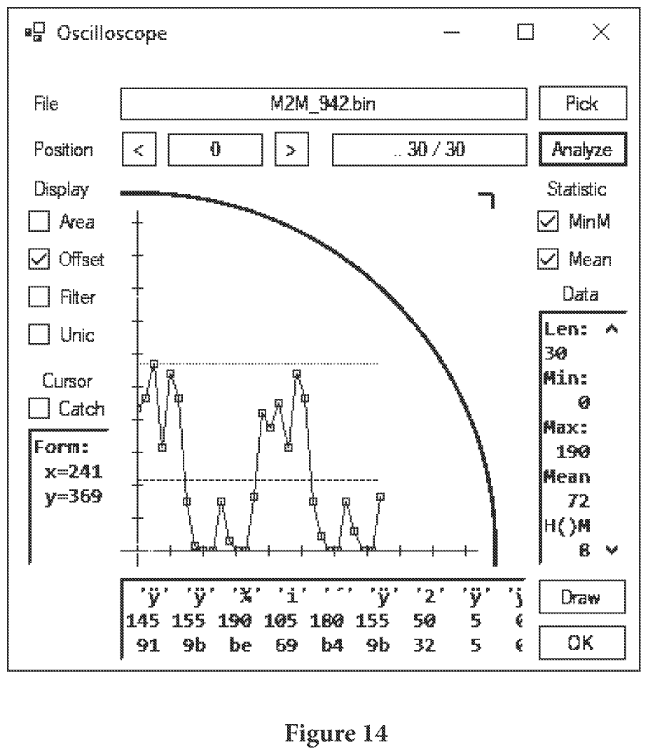

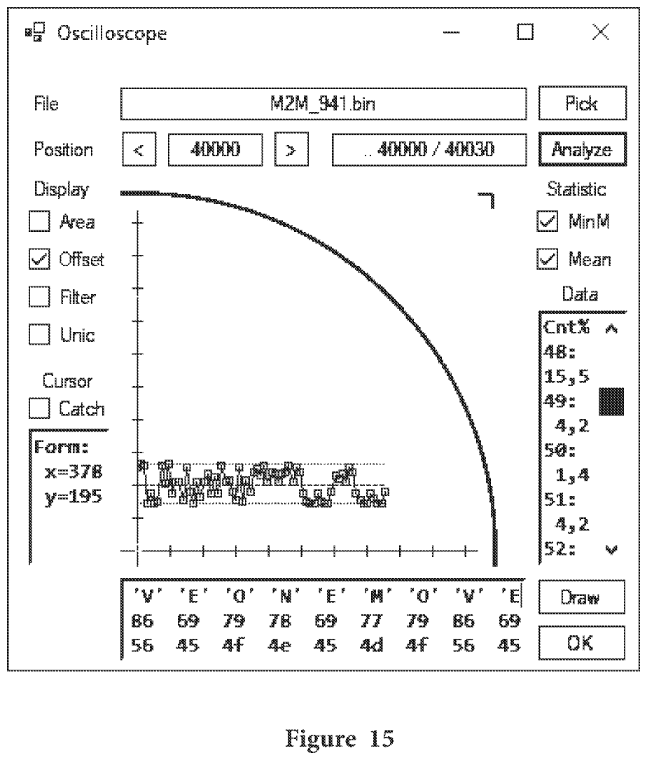

is improved and thus cannot be immediately identified as a machine protocol, as shown by FIGS. 13 and 14.

Similar to alterations of contents (inner alteration), an adaptation of the form (external alteration) is possible as a further measure against attacks. Using the data length, assumptions can be made on the file type. For example

<100 Bytes ASCII Text with important information auch as .ini, passwords, etc.

<2 kB a DIN A4 pagee (1800 characters)

<20 kB Office documents such as contracts, reports, and so on.

Above this, there are more sophisticated formats. Due to the file system, a minimal block size (cluster) is required, 64 kB is usual, including for the saving of one byte. Use can be made of this in the present encryption. By

[FillGroup]

ignore=40000

jump=40

firstly 40000 peudorandom numbers are prefixed, processed with another algorithm—independent of the actual encryption method (series through regular jumps in Base B of 40 bytes). Only then does the actual user data come, in sum an equal amount is covered, but the attacker does not know the value and thus it is significantly more difficult to find the actual beginning and to guess the true file type.

Further variants of groups are possible. The following can be stated as objectives:
altering the structure
changing the order, i.e. the arrangement
preventing regularity
altering the contents
altering the form of the cipher compared to the original and resulting in effects on form, content, scope, order, structures, etc.

These objectives are enabled by applying the ARTOO principle, where any number (OO) of random numbers (R) are available; a fast transformation (T) takes place in an automated (A) manner.

Further types of groups are conceivable. If many different types of groups are used within a file, a general entry in a configuration file is no longer sufficient. In that case, a group header must contain the peculiarities of the individual group of characters.

Accordingly, e.g. in emergencies, a limited encryption strength can ensure a minimum level of security during the communication. For differentiation, the version 0.0 is used in the header and uses an individual start position. Even in the case of a disaster, where the basis of data has broken down, an SOS radio message can be sent to the coastguard. Pirates can receive these, but not interpret them.

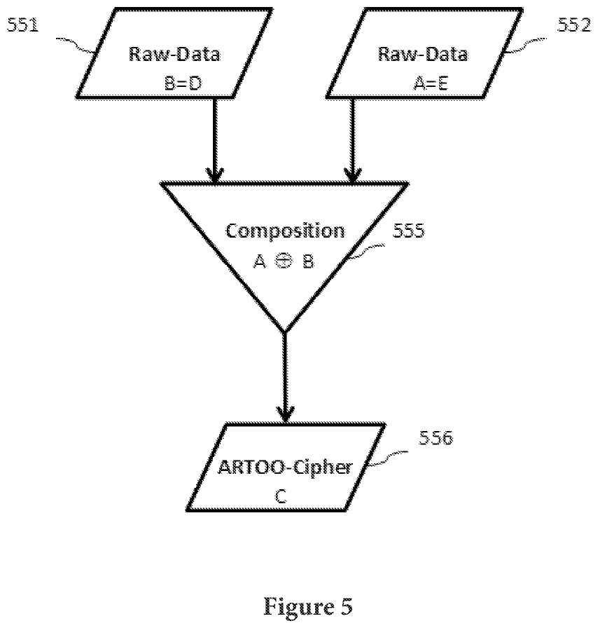

FIG. 5 depicts an embodiment of the encryption method according to the invention, in which the conversion is performed directly on the first B=D and second A=E digital data, i.e. the first and second digital data are not altered prior to the conversion.

Here, the data are linked (⊕) with a particular function, such as XOR individually consecutively mathematically, in an information processing manner, and saved as cipher C, e.g. a=255, b=1

c=255 XOR 1=254

It is common to all presented methods that the conversion A⊕B=C finally takes place. At the start, a particularly simple conversion was presented by addition: a+b=c. This too, can be established by means of a Start Condition and can be employed in compact devices, such as in a smart home thermostat. Through identical settings in the configuration file (.ini) on all devices (individually at the factory as a set) with

[Composition]

Function=+

Maximum=100

the base B is reduced with regard to the value range of D, then the Maximum+1=101 is required as the value for modulo (remainder function). As 0 is reserved for the jump behaviour, the value range from raw data D

[1 . . . 255]

changes to a value range of base B

[0 . . . 100]

with the value range of the working data A as ASCII

[0 . . . 127]

the target range (target quantity) of the cipher C is calculated from 0 to 227:

a+b=c

0+0=0

127+100=227

and thus cannot be immediately identified as ASCII code or a protocol for machine control. This particular type of conversion is entirely new and unusual.

Therefore, it will be explained in detail for the decryption. The same conditions prevail in the case of decryption as in the case of encryption (Start Condition). Thus, always the same value can be formed from B, regardless of how many jumps, functions, and which algorithms, etc. have been used until then. The process and uniqueness shall be illustrated with the above example. Firstly, the value for b is formed again by modulo 101 from D

b=d%(Maximum+1)

with a value for d up to and including the maximum, this is

b=100%101=100

for values greater than the maximum, an alteration takes place through modulo, e.g. 201

b=201%101=100

then, in both cases, according to the above example c=227

a=c−b

a=227−100=127

It is evident that a lot more conversions can now be used. Combinations or complex pictures can be used, as long as the inverse yields the actual original value without any loss. Regulation is performed by transition of the raw data D to the base data B.

The presented examples show various possibilities of influencing:
with the first digital data A as processing of the data
with the second digital data B as adaptations of the data
with the formation of the cipher C as conversion of the data
and in meaningful combination A, B, C

If several steps of the presented examples are employed one after the other, the steps must be executed in reverse order for the decryption. Only a few, particularly simple examples are mentioned here. The scope of functions is larger in practical application and is provided as a set of functions for the different matters. The actual selection and control is performed in accordance with the ARTOO principle in a non-predictable order (the R in ARTOO) with a non-forecastable quanitity (the OO). In this case, the scope of the functions is expandable (the OO), and therefore increases from version to version. As an overview, a quantity of functions would be conceivable in the respective sets, wherein the Version 2 assumes the existing 50 to be downwardly compatible (so that previous files from Version 1 can continue to be decrypted):

| Set (depending on the task) | Version 1.0 | Version 2.0 |
|---|---|---|
| Start position | 10 | 20 |
| Jump behaviour | 5 | 30 |
| Base current B | 10 | 40 |
| Working current A | 20 | 100 |
| Conversion cipher C | 5 | 10 |
| Total | 50 | 200 |

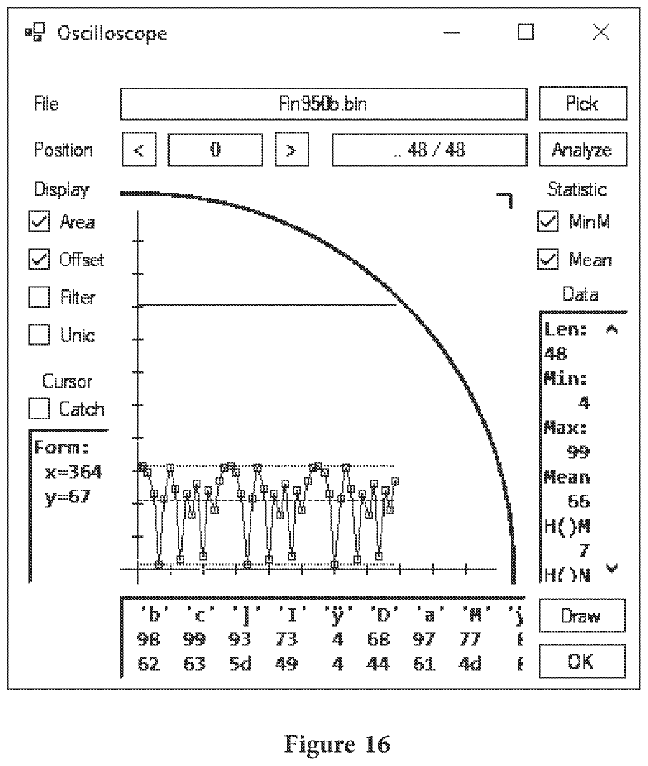

The final example takes up the situation at the beginning. There, a letter ‘p’ with 3*16 values of 0 to 15 was consulted to illustrate the pattern formation. The following example shows the power of this encryption through exclusive use of the addition. The variance of B has been increased by beginning at position 11, an auxiliary variable accu (Accumulate) for adding up 7 equal values, up to a maximum of 5 different values, which are not permitted to exceed a total of 100, as shown by FIG. 16.

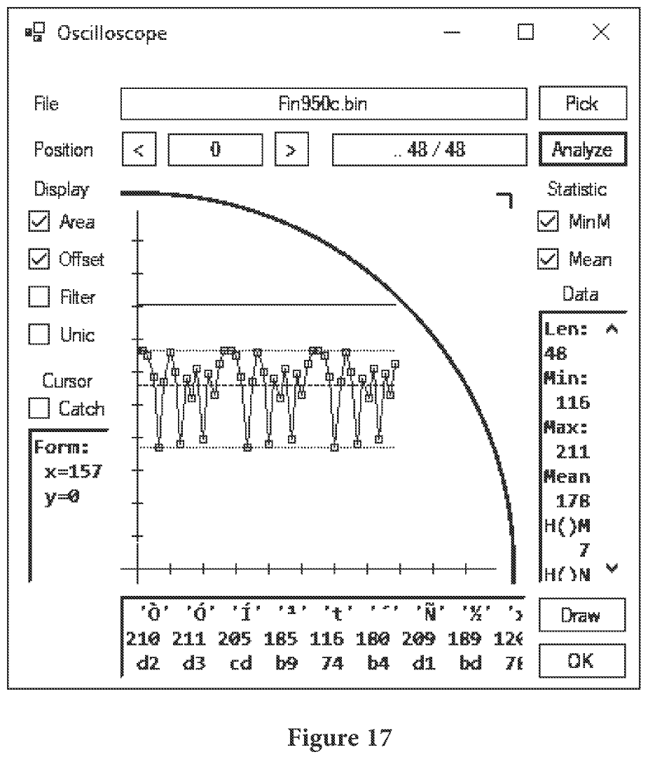

A cipher emerges from this through addition of 112 to the letter ‘p’ which is always the same from the working data to be encrypted, a pattern which is much harder to recognise, as depicted by FIG. 17. However, the automatic algorithm would summarise the sequence to 16*112, as depicted in FIG. 12.

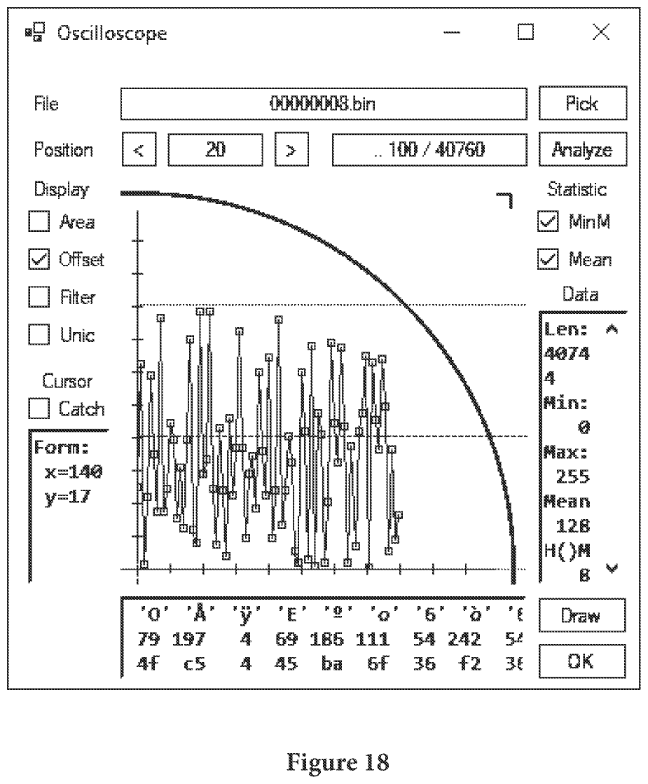

The last example, FIG. 18, shows the practice using the drawing-up of this document. For secure communication, the prototype for the file encryption was used. The following extract clearly shows the scatter (variance) through minimum, maximum, average, the information density of 8 bits as the maximum for one byte. It is an Office document, broken down into random groups and adapted. Partially, summarising was carried out (compression of approx. 5%), fill groups inserted (1%) and the structure was entirely altered through reorganisation. A JPEG image was used as the basis. Due to the high information density, the functions manage without additional processing. A few jumps occurred, caused by the required randomness. The time measurement resulted in less than 1/10 of a second for the encryption algorithm.

1. A method for encrypting digital data (A, E) by conversion, comprising the steps of:
accessing first digital data (D), wherein the first digital data (D) consist of at least one first unit, which has a data value and a data arrangement;
accessing second digital data (A, E), wherein the second digital data (A, E) consist of at least one second unit, which has a data value and a data arrangement;
establishing a start condition, wherein the start condition has at least one start position based on the data arrangement of the first digital data;
persistently retaining the data of the start condition;
forming a first temporary data stream (B) from the first digital data (D) as a function of the start condition;
and forming a cipher (C) by converting the second digital data (A, E), wherein the at least one second unit (a∈A) is converted using at least one predetermined function (⊕) as a function of at least one third unit (b∈B) selected from the first temporary data stream (a⊕b=c)
characterised in that the first temporary data stream is a circular data stream.

2. The method according to claim 1, characterised in that the formation of the first temporary data stream (B) furthermore comprises mathematical, stochastic and/or information-technology processing of first digital data.

3. The method according to claim 1, characterised in that the at least one third unit is selected from the temporary data stream by means of a predetermined ruleset.

4. The method according to claim 1, characterised in that the conversion takes place using the at least one predetermined function as a function of the data value and/or the data arrangement of the at least one third unit.

5. The method according to claim 1, characterised in that the second digital data (A) are formed by adaptation prior to conversion by means of mathematical, stochastic and/or information-technology processing based on digital raw data (E).

6. The method according to claim 5, characterised in that the mathematical, stochastic and/or information-technology processing is a reversible alteration of the arrangement of groups of second units.

7. The method according to claim 1, characterised in that the second digital data (E) form a second temporary data stream (A).

8. The method according to claim 1, characterised in that the start condition is saved in connection with the cipher (C).

9. The method according to claim 1, characterised in that, if it is not possible to access the first digital data, an appropriate replacement is accessed.

10. A method for decrypting a cipher (C), which is formed according to claim 1, comprising the steps of:
accessing the cipher (C);
accessing a start condition;
accessing first digital data (D), wherein the first digital data (B, D) consist of at least one first unit, which has a data value and a data arrangement and corresponds to the digital data used for the encryption;
reversal of the conversion, wherein in each case one unit of the cipher (c□C) is formed by reversed application of a predetermined function used in the encryption, as a function of at least one third unit, wherein the at least one third unit is a unit from a first temporary data stream (B), wherein the first temporary data stream (B) is formed from the first digital data (D) as a function of the start condition.

11. A method for decryption according to claim 10, wherein the method comprises the reversal of the adaptations by performing, in reverse order, the steps performed during the adaptations on the second digital data (A).

12. A device for encrypting or decrypting digital data comprising a processor and a storage medium, characterised in that the device is configured to carry out the method according to claim 1.

13. A computer program with program code for performing the method according to claim 1, when the computer program is executed on a processor.

14. A storage medium with instructions saved thereon for performing the method according to claim 1, when these instructions are executed on a processor.

15. A device for encrypting or decrypting digital data comprising a processor and a storage medium, characterised in that the device is configured to carry out the method according to claim 10.

16. A computer program with program code for performing the method according to claim 10, when the computer program is executed on a processor.

17. A storage medium with instructions saved thereon for performing the method according to claim 10, when these instructions are executed on a processor.
